(19) United States
(12) Patent Application Publication
(10) Pub. No.: US 2007/0203792 A1
(43) Pub. Date: Aug. 30, 2007

(54) Electronic device capable of delivering coupons to a POS system and to a sales server

(76) Inventor: Bindu Rama Rao, Laguna Niguel, CA (US)

Correspondence Address: BINDU RAMA RAO, 21 HENLEY DRIVE, LAGUNA NIGUEL, CA, 92677, US

(21) Appl. No.: 11/712,811

(22) Filed: Feb. 28, 2007

Related U.S. Application Data
(60) Provisional application No. 60/777,470, filed on Feb. 28, 2006.

(51) Int. Cl. G06Q 30/00; G06Q 20/00

(52) U.S. Cl. 705/14; 705/16

(57) ABSTRACT

Using the coupons stored in an electronic device, a user can reduce the cost of their purchases during a sales event conducted with the point-of-sale (POS) device. The user can download coupons and rebate information to the electronic device from a sales portal, or they can be sent to the electronic device by the sales portal, such coupons are used in sales transactions with POS computers or even in online sales transactions. A sales client in the electronic device facilitates successful completion of interrupted sales transactions.

### CROSS REFERENCES TO RELATED APPLICATIONS

The present application is a makes reference to, claims priority to, and claims benefit of U.S. Provisional Application Ser. No. 60/777,470 entitled “ELECTRONIC DEVICE CAPABLE OF DELIVERING COUPONS TO A POS SYSTEM AND TO A SALES SERVER” (Attorney Docket No. BRR2006US01) filed Feb. 28, 2006, the complete subject matter of which is hereby incorporated herein by reference, in its entirety.

The present application also makes reference to, is based on and claims priority to the U.S. patent application Ser. No. 11/130,751, entitled “SYSTEM AND METHOD FOR MANAGING SALES COMPLETION ON MOBILE DEVICES” (Attorney Docket No. GH2004US02), filed May 17, 2005, which is a conversion of the provisional application titled “SYSTEM AND METHOD FOR MANAGING SALES COMPLETION ON MOBILE DEVICES”, filed May 17, 2004. The complete subject matter of both of these patent applications are hereby incorporated herein by reference, in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention generally relates to sales interactions at a point-of-sale device in a store infrastructures, and, more particularly, to interactions between the point-of-sale device and a mobile device.

2. Related Art

Electronic devices, such as mobile phones and personal digital assistants (PDA's), often contain small screens with very limited viewing area. They are constrained in terms of how much information can be displayed, and in terms of user interaction capabilities. The keyboards on cell phones, for example, are not conducive for user data entry, and only brief user inputs can be solicited from a user without annoying the user.

Today, there exist a few techniques for distribution of electronic coupons (e-coupons) to potential customers. A seller of a service or product can distribute mass email messages with e-coupons attached to or within the message. The seller then hopes that at least some of the potential customers who receive the messages will redeem the e-coupons included. Additionally, a seller can post an e-coupon on a web site, whether or not owned by the seller, and hope that a potential customer will see the e-coupon and choose to redeem it. Similar techniques exist for targeted distribution of coupons to attract potential customers who live local to a seller. For example, local restaurants or stores can attempt to attract customers on web pages local to a particular city. A city newspaper may have a website and these local sellers can post e-coupons on the site with the same hope of a customer seeing the e-coupon and choosing to redeem it.

People have the habit of paying for their purchases using credit cards or smartcards. However, they have no easy means to use their coupons, other than handing over a printed coupon or a coupon cut from a newspaper or flyer to a sales clerk and having the sales clerk use it (scan it or enter it) during a sales transaction. Sales clerks typically scan a coupon over or using a laser scanner communicatively coupled to a point of sale device.

Distributing coupons to people using flyers, or emailing them to users, and other techniques tend to be expensive to sellers and highly inefficient in attracting potential customers. The mass emails and e-coupon distribution carry a fixed cost based upon a hope that a potential customer exists. A seller must pay the website provider in order to put its e-coupons on the website, without any assurance at all that the e-coupons will be requested and redeemed by customers. A need exists to allow for distribution of an e-coupon to people. A need exists to make it easy for users to use these coupons.

Generally, potential customers choose a particular type of service or product and then seek to find the service or product based upon some need, whether such need is based on cost, ease of acquisition, location, or some other factor. A seller has a substantially increased opportunity to ensure that an e-coupon is redeemed because the customer initiates the desire for the e-coupon rather than a random e-coupon being sent to a customer. However, the e-coupons have to be printed out and taken to a store to be used during a sale, typically a sales clerk is given the coupon and the sales clerk scans it or enters it using a keyboard, to deduct the value of the coupon from the total sales price.

Some mobile devices employs a contactless card such as “felica”. Some information on Felica cards is found at the reference http://www.sony.net/Products/felica/abt/dvs.html. In addition, additional information on how NTT Docomo in Japan is using felica cards is found at the reference website http://www.nttdocomo.com/corebiz/services/imode/felica.html. New multi-interface combination cards with support for FeliCa are available from Visa. Sony Corporation and Infineon Technologies have jointly developed a single-chip multi-application GlobalPlatform chip product that supports Visa Smart Debit/Credit payment alongside contactless applications based on Sony's FeliCa technology, as well as ISO 14443 type A and type B interfaces. This development will make it easier for VISA members to implement value-added applications such as mass transit, loyalty and e-purse on Visa payment cards. The new A/B/FeliCa GlobalPlatform combi-card has be available since 2004.

The Visa contactless cards removes the need to physically insert a smart card into a reader. Based on the international standard ISO 14443, the new contactless payment specification will support a faster and more convenient way to pay and be paid, particularly in environments where access to traditional, card-based payment methods has been limited. The first use of this new contactless specification has been in Korea, where SK Telecom seems to have developed mobile products based on the Visa specifications. SK Telecom and Visa have been working together since April 2002 to test the viability of infrared payment for mobile phone users.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Invention, and the Claims.

In accordance with the present invention, a mobile device interacts with a point-of-sale (POS) device in order to communicate account information and coupons during a sales transaction. The mobile device comprises a plurality of coupons, rebates, discounts, etc. that can be selectively delivered to the POS device.

These and other advantages and novel features of the present invention, as well as details of an illustrated embodiment thereof will be more fully understood from the following descriptions and drawings.

### BRIEF DESCRIPTION OF THE DRAWINGS

FIG. 1 is a perspective diagram of a sales network wherein an electronic device, such as a mobile device, with a programmed card is able to access services made available by a provider or operator providing the programmed card, wherein the programmed card not only provides the user's authorization to use the network, but also a mechanism to interact with a point-of-sale device such that it can exchange information, such as coupons, etc. with the point-of sale device.

FIG. 2 is a perspective block diagram of a sales environment wherein an electronic device with an account information and a collection of coupons interacts with a point of sale computer in order to facilitate the sales transaction for a user;

FIG. 3 is a interaction diagram showing exemplary interactions between an electronic device, a POS computer and a sales promotion server.

FIG. 4 is an interaction diagram showing exemplary interactions between a mobile device, which is a mobile handset or PDA typically, an online sales server and a sales promotion server, wherein a coupon delivered and stored in the mobile device is consumed in online sales transactions conducted with the online sales server.

### DETAILED DESCRIPTION OF THE INVENTION

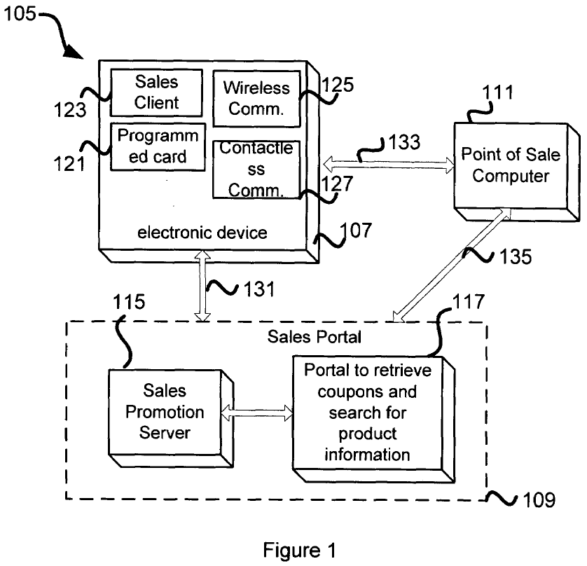

FIG. 1 is a perspective diagram of a sales network 105 wherein an electronic device 107, such as a mobile device 107, with a programmed card 121 is able to access services made available by a provider or operator providing the programmed card 121, wherein the programmed card 121 not only provides the user's authorization to use the network 105, but also a mechanism to interact with point-of-sale device 111 such that it can exchange information, such as coupons, etc., with the point-of sale device 111. Using the coupons stored in the electronic device 107, a user can reduce the cost of their purchases during a sales event conducted with the point-of-sale (POS) device 111.

In general, the sales network 105 comprises the electronic 107, such as a mobile device 107, with a programmed card 121 (that is one of a SIM card, Smart card 107, debit card, credit card, a bank card, or a combination of some of these) a point of sale device 111, and a sales portal 109 that facilitates sales promotion activities. The user can download coupons and rebate information to the electronic device from the sales portal 109, or they can be sent to the electronic device 107 by the sales portal 109. The sales portal comprises a sales promotion server 115 communicatively coupled to a portal to retrieve coupons and search for product information 117. The point of sale device 111 can be a computer or a handheld sales device with an interface for interactions with the electronic device 107. Such interactions are not restricted to the transfer of coupons and rebate information between the two, and may involve communicating credit card account information from the electronic device 107 to the POS 111 and the transfer of receipts and sales transaction details from the POS to the electronic device 107. Interactions between the electronic device 107 and the POS 111 occurs over a communication link 133, which may be one of a wireless connection over a wireless communication component 125, such as an IrDA connection, a 802.11 based communication means, a wireless USB means, and a Bluetooth, or a contactless connection over a contactless communication component 127, such as those used in the Felica cards. Other communication means are also contemplated for the communication link 133.

The sales client 123 facilitates sales transactions with the POS computer 111 or with online sales systems at the sales portal 109. It is capable of downloading coupons, storing coupons, using it in a sales transaction (online or with POS computer 111) and conducting sales transaction with or without active user participation. In particular, it completes interrupted sales transactions, wherein it reuses a coupon and sales profile information of a user, as appropriate to successfully complete an interrupted sales transaction.

The sales client 123 in the electronic device supports both coupon delivery/usage for sales transactions with a POS computer 111 but also online sales transactions conducted with online sales portals and online sales activities with merchants stores (with sales clerks).

In one embodiment, the programmed card 121 is a SmartCard that comprises a Subscriber Identification Module information used in wireless networks. It holds all of a user's subscription information, phone settings and email settings for a default email account for the prepaid card user that the user can use to receive and send emails, or at least to forward email to the user's default email server, that is perhaps outside the operator's network 109. It also holds coupons downloaded (or sent) to the electronic device 107 from the sales portal 109.

In general, the data related to coupons (and other user specific or account specific data) is exchanged with the POS 111 by mere proximity, without the need for physical contact. The programmed card 121 can be used to store downloaded coupons and rebate information, such information being employed in sales transactions conducted with the POS 111. The user of the electronic device 107 comprising the programmed card 121, such as a FeliCa card 121, can use the programmed card 121 and the coupons stored in it for several different reasons, such as to log on to a computer at an Internet kiosk and use a coupon as part of the associated transaction. The coupons can be stored in the programmed card 121 in one embodiment and in storage space (such as FLASH memory) of the electronic device 107 accessible by the programmed card 121 in another.

In one embodiment, the mobile device 107 comprises a programmed card 121, such as a felica card, that is capable of interacting with a merchant's point-of-sale device 111 via contactless and/or infrared technology. Sales transactions are conducted via the point-of-sale device 111 with the mobile device 107 communicating a coupon, a voucher or a rebate to the point-of-sale device 111 in order to provide the user a cost reduction on the items being purchased.

In one embodiment, the electronic device 107 is a portable digital device 107 with a FeliCa chip used as the programmed card 121. This makes it possible for the portable device 107 to contain multiple forms of data including personal or business identification (ID) information, bank account numbers and balances, medical information, credit account data, transportation passes, and authorization codes. In addition, the portable device 107 contains a plurality of coupons that can be transferred to the point-of-sale device 111. In other embodiments, the electronic device 107 is a cell phone, a handheld computer, a wristwatches, or a calculator, each of them comprising a programmed card 121 that is a contactless card, such as Felica chip based card, each of them capable of storing and transferring coupons (or coupon related information). For example, a user can upload digital cash from a credit card to a cell phone set 107 and also upload coupons for later usage during a sales event. In the case of a wristwatch device 107 that is capable of storing coupons, the user can pass the wristwatch 107 near a scanning device at a department store checkout station, and be able to employ at least one of the coupons saved as part of a sales transaction. Similarly, in the scenario where a calculator 107 is used to store coupons, the user can use the calculator device with a programmed card 121 as a virtual train ticket and use a train ticket coupon to purchase a train ticket (for example).

In one embodiment, an electronic device 107 has a programmed card that is a SmartCard. A user downloads coupons onto the SmartCard from the sales portal or other websites, or stores those received from email or communicated from any other means. In a sales event associated with the POS, the user has the option to transfer the coupon to the POS. The user can browse through stored coupons and initiate the transfer of one or more coupons stored. The POS receives them and incorporates them into the sales totals. Optionally, the POS verifies the authenticity of the coupons, typically via the Internet, with the help of the sales portal or other servers. The transfer of the coupon from the electronic device to the POS takes place over Bluetooth connection, or an IrDA connection. Other communications means are also contemplated.

Using the coupons stored in the electronic device 107, a user can reduce the cost of their purchases during a sales event conducted with the point-of-sale (POS) computer 111. The user can download coupons and rebate information to the electronic device 107 from a sales portal 109, for subsequent usage during a sales transaction, both for a POS computer or online with a sales server. Coupons can be sent to the electronic device by the sales portal 117, such coupons are used in sales transactions with POS computers 111 or even in online sales transactions wherein products can be selected and appropriate coupons applied. The sales client 123 in the electronic device 107 facilitates successful completion of interrupted sales transactions. Rebate information in the electronic device 107 is filled in with sales related information and the completed rebate information is communicated to a manufacturer's online rebate system or to other systems, as needed, or even printed with the help of the sales client 123 for mailing by traditional mailing services.

In one embodiment, the electronic device 107 is a mobile device 107 such as a mobile phone that is capable of data services as well as voice services, and the programmed card is one of a SIM card, SmartCard (such as URIM, USIM, RIM, etc.) is used to authenticate the user in an operator network. The sales client is used to download coupons, store coupons and use them in sales transactions. The sales transactions are conducted in the mobile device 107 with the help of the sales client 123 either with the POS computer 111 or with an online sales server, such as the sales portal 109. The sales client 123 makes it possible to resume interrupted sales transaction that may involve coupon delivery initially before the interruption and coupon redelivery after resuming the sales transaction. Resumption of the interrupted sales transaction occurs automatically or with user consent, based on user preferences and configuration. The sales client 123 delivers coupons to a POS computer 111 using wireless means over wireless communication 125, such as bluetooth, 802.11, IrDA, wireless USB, WIMAX, etc. The sales client 123 also delivers coupons to a the sales portal 109 or to other sales websites, as part of an online sales transactions over wireless data services, using wireless means over network connections 131 such as GPRS, EDGE, 3G data services, etc.

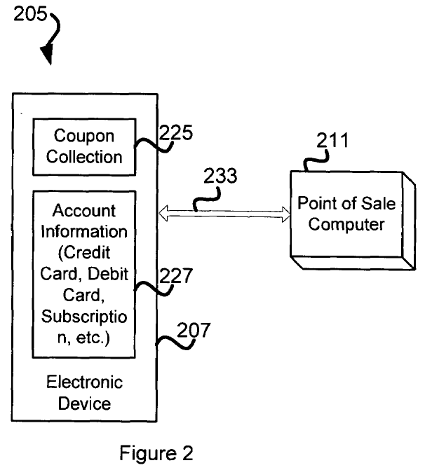

FIG. 2 is a perspective block diagram of a sales environment 205 wherein an electronic device 207 with an account information 227 and a collection of coupons 225 interacts with a point of sale computer 211 in order to facilitate the sales transaction for a user. The mobile device 207 with the account information 227 is capable of using one or more coupons currently stored in the coupon collection 225 to conduct a sales transaction with the help of the POS. The mobile device 207 comprises the account information 227, which is one or more of a credit card information, a debit card information, a subscriber identity information, etc. The account information can be set by a user, or prepopulated or configured by a server, such as a provisioning server of a wireless network operator or a server associated with a bank.

The sales environment 205 comprises the mobile device 207, the POS computer 211 and the communication link 233, which is a wireless communication link, such as IrDA or bluetooth. At the end of a sales transaction involving the account information 227, one or more coupons from the coupon collection 225, and the POS computer 211, involving a one or more products or services desired by the user of the electronic device, the POS computer 211 causes the removal or deletion of the one or more coupons from the coupon collection 225 that are used or consumed in the sales transaction.

The electronic device 207 is capable of sending a notification to the POS computer 211 that it has in its store one or more coupons that the user intends to use during a sales transaction. The user typically initiates the sending of such a notification using an activation sequence (such a keystrokes on a keyboard on the electronic device 107 or a button on the electronic device 207). Alternatively, the POS computer 211 causes a search of all stored coupons for associated/relevant ones based upon items selected for purchase by a user, the electronic device 207 being able to receives such instructions for coupons searches and acting upon it. A search criteria (such as product item identifications, or product SKEW information, etc.) is communicated by the POS computer 211 to the electronic device 207 that is used in determining the availability of coupons in the coupon collection 225 that can be used is a current sales transaction.

In one embodiment, a coupon manager application is embedded in the programmed card that encloses the account information 227. Using the coupon manager application, in the programmed card associated with the account information 227 (such as a SIM Card, SmartCard, Felica chip, etc.), the user/subscriber of the electronic device 207 can manage coupons, add, delete, download, and use coupons in sales transactions with the POS computer 211.

Although the FIG. 2 is described in terms of account information, it should be understood that account information can be embodied in SIM, USIM, RIM, WIM, Smart Cards, Contact-less cards and other similar removable devices that are employed by mobile devices for identification and security.

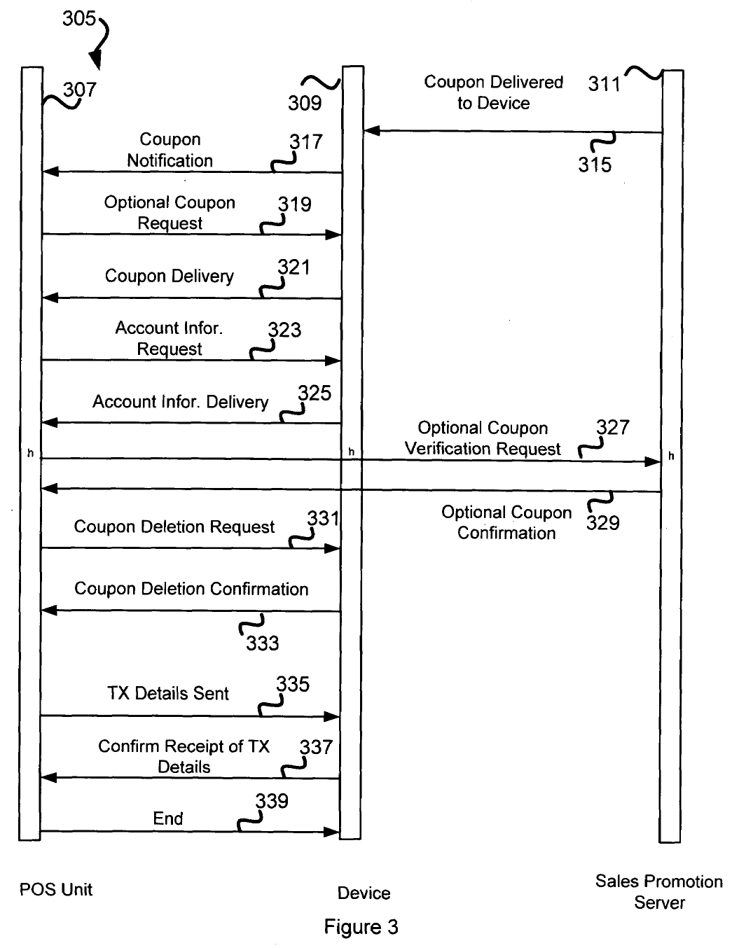

FIG. 3 is a interaction diagram showing exemplary interactions 305 between an electronic device 309, a POS unit 307 and a sales promotion server 311. The user of the electronic device may initiate the download of a coupon 315 or it may be delivered to the electronic device by the sales promotion server 311. The user may subsequently initiate a sales transaction with the POS unit 307, and may intend to use the coupon in a sales transaction. The existence of the coupon (one or more coupons) is communicated by the electronic device 309 by means of a coupon notification 317. Then, optionally, the POS unit 307 may make a request for a coupon 319. The requested coupon is delivered 321 if it is located by the electronic device 309 to the POS unit 307. Then, the POS unit requests account information 323 such as a credit card information or a subscriber identification information, in order to charge sales related charges to an account associated with the user. The account information is delivered 325 by the electronic device 309.

The POS unit 307 can optionally seek verification of coupon 327 delivered from the sales promotion server 311. The coupon confirmation (or rejection) 329 is delivered to the POS unit 307 by the sales promotion server 311. After the coupons have been consumed for a current sales transaction, the coupon deletion request 331 is sent by the POS unit 307 to the electronic device 309. The coupon deletion confirmation 333 is sent by the electronic device 309 to the POS unit 307. The sales transaction details 335 is communicated to the electronic device 309 by the POS unit 307. The confirmation receipt for the sales transaction details is sent by the electronic device 309 to the POS unit 307. Finally, the end of transaction message is sent by the POS unit 307 to the electronic device 309.

The over-the-air (OTA) sales transaction support with coupons by the electronic device 309 is complemented by the features in the POS unit 307 that facilitates coupon receipt from the electronic device 309

The user can initially set up delivery mechanism for coupon via email or downloads from sales promotion portals or other servers. Subsequently, the user of the mobile device 307 can access one or more coupons, for transfer to the POS unit.

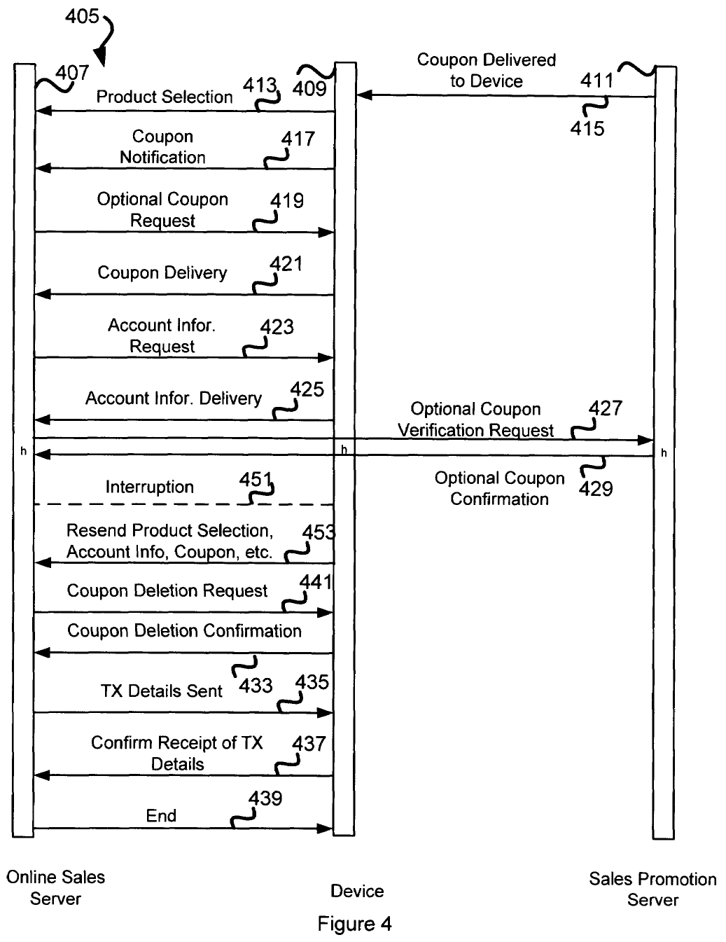

FIG. 4 is an interaction diagram showing exemplary interactions 405 between a mobile device 409, which is a mobile handset or PDA typically, an online sales server 407 and a sales promotion server 411, wherein a coupon delivered and stored in the mobile device 409 is consumed in online sales transactions conducted with the online sales server 407. The user of the mobile device 409 may search and retrieve coupons from the sales promotion server 411 or the coupon is delivered 415 to the mobile device 407 sales promotion server 411. The coupon is then consumed during online sales transactions conducted by a user (using one or more stored coupons) with the online sales server 407. For example, such interactions are possible between the electronic device 107, which is a mobile device 107, a sales portal 109 and a sales promotion server 115, wherein the sales portal 109 provides products for sale and is capable of interacting with the sales promotion server 115 to verify coupons etc.

The user of the mobile device may 409 initiate the download of a coupon 415 or it may be delivered 415 to the mobile device 409 by the sales promotion server 411. The user may subsequently initiate a sales transaction with the online sales server 407, and may intend to use the coupon in a sales transaction after initial product selection 413 of one or more products to be purchased. The existence of the coupon (one or more coupons) is communicated by the mobile device 409 by means of a coupon notification 417. Then, optionally, the online sales server 407 may make a request for a coupon 419 at the appropriate time, such as after final product selection by a user and specification of an optional preferred shipping address. The requested coupon(s) is delivered 421 if it is located by the mobile device 409. Then, the online sales server requests account information 423 such as a credit card information or a subscriber identification information, in order to charge sales related charges to an account associated with the user.

The account information is delivered 425 by the electronic device 409. The account information is data that is entered into the mobile device by a user using a keyboard on the mobile device, typically conducted one time during the setup of the mobile device. It can be subsequently changed and updated by the user. A sales client in the mobile device 409 facilitates the maintenance and update of the account information. The user can also go online to a self-care portal and update or otherwise manage the account information, which results in the account information in the mobile device 409 being updated or otherwise managed by the user. In some embodiments, the account information also comprises user's shipping address, billing address, shipping and delivery preferences, etc.

The online sales transactions may be prematurely terminated due to network coverage issues of the underlying bearer communications, due to device malfunctions or due to problems encountered by the online sales server 407. The sales client in the mobile device 409 is capable of recovering from such interruption 451 and resuming the sales transaction, often automatically, when the encountered problem is solved or the communications with the online sales server 407 is found to be feasible again. Sales transactions may be interrupted by the user, and it can still be resumed subsequently by the sales client.

After the interruption 451 is overcome, the sales client in the mobile device 409 resends 453 product selection by the user, account information, coupons used, etc. to the online sales server 407 to resume the previously interrupted sales transaction. Then, the online sales server 407 can request coupon deletion 441, send transaction details 435 and finally end the transaction 439 successfully.

Although a system and method according to the present invention has been described in connection with the preferred embodiment, it is not intended to be limited to the specific form set forth herein, but on the contrary, it is intended to cover such alternative, modifications and equivalents, as can be reasonably included within the spirit and scope of the invention as defined by this disclosure and appended diagrams.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An electronic device that can be used for a sales transaction by a user wherein the sales transaction is conducted with a point-of-sale (POS) device, the sales transaction comprising at least one item that is purchased and a total amount, the electronic device comprising:
an account information stored in the electronic device, that is communicated by the electronic device to the point-of-sale device during the sales transaction;
a coupon stored in the electronic device that can be used to reduce the total amount associated with the sales transaction conducted with the POS device;
the electronic device capable of receiving a request for the coupon from the POS device and determining if it has the coupon;
the electronic device selectively communicating the coupon to the POS device, when requested, during the sales transaction, thereby reducing the total amount associated with the sales transaction.

2. The electronic device according to claim 1 wherein the electronic device automatically determines if the coupon stored in the electronic device is appropriate for the at least one item that is purchased and communicating the coupon automatically to the POS device if it determines that to be the case.

3. The electronic device according to claim 1 wherein the electronic device stores a plurality of coupons and wherein the electronic device automatically determines if at least one of the plurality of coupons stored in the electronic device is appropriate for the at least one item that is purchased and communicating those of the plurality of coupons that are determined to be appropriate automatically to the POS device during the sales transaction.

4. The electronic device according to claim 3 wherein the electronic device deletes those of the plurality of coupons after they have been communicated to the POS device.

5. The electronic device according to claim 1 further comprising:
a sales client;
the sales client facilitating the download of the coupon to the electronic device from a sales portal communicatively coupled with the electronic device;
the sales client deleting the coupon if the coupon expires before it is employed in the sales transaction;
the sales client employing the coupon in the sales transaction conducted with the POS device when the sales client determines that it is appropriate to use the coupon in the sales transaction; and
the sales client deleting the coupon after it has been employed in the sales transaction.

6. The electronic device according to claim 5 further comprising:
the electronic device capable of interacting with the POS device when the POS device is a remote sales server;
the electronic device communicatively coupled to the remote sales server via one of a cellular network, a WLAN network, a WiFi based wireless network, Internet, and a WIMAX based wireless network;
the sales client facilitating completion of an interruption in the sales transaction by reestablishing a communication with the remote sales server and providing coupons appropriate for the sales transactions more than once if necessary.

7. The electronic device according to claim 1 further comprising:
a programmed card that manages the account information stored in the programmed card;
a coupon manager application embedded in one of the programmed card and the electronic device;
the coupon manager application managing the addition of the coupon, the deletion of the coupon, the download of the coupon and use of the coupon in the sales transaction with the POS device.

8. The electronic device according to claim 7 wherein the programmed card is a contactless Felica card IC chip embedded in the electronic device.

9. The electronic device according to claim 7 wherein the programmed card is one of SIM Card, SmartCard, Felica card IC chip based module, and a credit card.

10. The method of conducting a sales transaction between a mobile device and a point-of-sale (POS) device, the method comprising:
authenticating mutually, by the mobile device and the POS device;
notifying, by the mobile device, availability of at least one coupon corresponding to the sales transaction;
requesting, by the POS device, information regarding the at least one coupon;
delivering, by the mobile device, information regarding the at least one coupon;
communicating, by the mobile device, an account information and associated security information to the POS device;
adjusting, by the POS device, the total amount for the sales transaction incorporating the at least one coupon;
sending, by the POS device to the mobile device, a final transaction details; and
deleting, by the POS device, selectively, the at least one coupon.

11. The method according to claim 10 wherein notifying further comprises:
determining the purchase items in the sales transaction by the mobile device;
identifying those of a plurality of coupons stored in the mobile device that can be employed in the sales transaction; and
collecting the at least one coupon for subsequent delivery to the POS device.

12. The method according to claim 11 wherein determining comprises the POS device communicating a list of user selected purchase items to the mobile device and wherein identifying comprises searching through a collection of stored coupons in the mobile device for relevant ones based upon the list of user selected purchase items.

13. The method according to claim 12 wherein searching comprises creating a search criteria for processing the collection of stored coupons based on at least one of product item identification, product SKEW information, a manufacturer name and a company name.

14. The method according to claim 10 wherein communicating further comprises:
retrieving the account information and associated data;
encrypting the account information and associated data; and
transferring the account information and associated data.

15. The method according to claim 14 wherein the account information comprises one or more of a credit card information, a debit card information, and a subscriber identity information.

16. A point-of-sale (POS) device that is used to conduct sales transactions, the POS device comprising:
an interface to interact with a mobile device to which the POS device is communicatively coupled, the mobile device comprising a programmed card, the programmed card being capable of storing an account information and at least one of a coupon, discount information and manufacturer's rebate and providing them to the POS device;
the POS device communicating a list of purchased items and receiving the at least one of a coupon, discount information and manufacturer's rebate associated with at least one of the list of purchased item, along with an account information, from the mobile device; and
the POS device incorporating the at least one of a coupon, discount information and manufacturer's rebate received from the mobile device into the sales transaction.

17. The POS device according to claim 16 wherein the POS device communicates a sales information to the mobile device at the end of a sales transaction wherein the sales information is at least one of an invoice and a sales receipt.

18. The POS device according to claim 17 wherein the POS device receives an approval from a user via the mobile device after it communicates the at least one of an invoice and a sales receipt to the mobile device, and, in response, conducts a billing transaction with a remote billing server.

19. The POS device according to claim 16 wherein the POS device causes a search of all stored coupons in the programmed card and retrieval of the at least one of a coupon, discount information and manufacturer's rebate coupons from the mobile device by providing the list of purchased items.

20. The POS device according to claim 16 selectively seeking verification of coupon the at least one of a coupon, discount information and manufacturer's rebate coupons retrieved from the mobile device from a server and receiving one of a confirmation or a rejection in response from the server.
